(19) United States
(12) Patent Application Publication
(10) Pub. No.: US 2009/0063217 A1
(43) Pub. Date: Mar. 5, 2009

(54) MULTI-STAGED AND MULTI-VIEWPOINT CHOREOGRAPHY MODELING

(75) Inventor: Alistair P. Barros, Camira (AU)

Correspondence Address: BRAKE HUGHES BELLERMANN LLP, C/O INTELLEVATE, P.O. BOX 52050, MINNEAPOLIS, MN, 55402, US

(73) Assignee: SAP AG, Walldorf (DE)

(21) Appl. No.: 11/848,404

(22) Filed: Aug. 31, 2007

(51) Int. Cl. G06Q 10/00

(52) U.S. Cl. 705/7; 705/1

(57) ABSTRACT

A choreography manager may be configured to manage a choreography model governing interactions between at least two entities. The choreography manager may include a first choreography modeler configured to provide a first view of the choreography model, the first view including first constructs that are associated with a first sequence degree characterizing a degree to which a sequence of the interactions between the entities is provided. The choreography manager may include a second choreography modeler configured to provide a second view of the choreography model, the second view including second constructs that are associated with a second sequence degree characterizing the degree to which the sequence of the interactions between the entities is provided. The choreography manager may include a choreography mapper configured to relate the first view to the second view, and configured to relate the first constructs to the second constructs.

### TECHNICAL FIELD

This description relates to process models.

### BACKGROUND

Modeling languages may be used as meta-languages to describe and execute underlying processes, such as business processes. For example, process modeling languages allow an enterprise to describe tasks of a process, and to automate performance of those tasks in a desired order to achieve a desired result. For instance, the enterprise may implement a number of business software applications, and process modeling may allow coordination of functionalities of these applications, including communications (e.g., messages) between the applications, to achieve a desired result. Further, such process modeling generally relies on language that is common to, and/or interoperable with, many types of software applications and/or development platforms. As a result, for example, process modeling may be used to provide integration of business applications (e.g., software services), both within and across enterprise organizations.

Thus, such modeling languages allow a flow of activities to be graphically captured and executed, thereby enabling resources responsible for the activities to be coordinated efficiently and effectively. The flow of work in a process is captured through routing (e.g., control flow) constructs, which allow the tasks in the process to be arranged into the required execution order through sequencing, choices (e.g., decision points allowing alternative branches), parallelism (e.g., tasks running in different branches which execute concurrently), iteration (e.g., looping in branches) and synchronization (e.g., the coming together of different branches).

Choreography modeling refers to a type of process modeling that is generally concerned with a coordination of a plurality of organizations, persons, groups, stakeholders, or other entities. Generally, each such entity may have its own area(s) of expertise and may have its own associated process models. A choreography model may thus serve as a global or over-arching process model, which provides a contract or framework within which the various entities may execute their own process models (also known as local process models or orchestration models), while having confidence that their partner entities will behave in an expected, predictable, and workable manner.

Since choreography models, by their nature, often deal with a large number of entities having complex types and sequences of interactions, it may be difficult to design and implement a choreography model. Even if a monolithic choreography model is successfully constructed, it may be overly complex for some participating entities to use in a desired or intended manner. Moreover, once wholly or partially implemented, it may be difficult to modify the monolithic choreography model, due, for example, to the interrelated nature of the entities and associated message interactions (e.g., modification of one portion of the choreography model may cause an unintended effect in another portion). Consequently, for these and other reasons, an ability of users to design, use, and benefit from choreography models may be limited.

### SUMMARY

According to one general aspect, a system may include a choreography manager configured to manage a choreography model governing interactions between at least two entities. The choreography manager may include a first choreography modeler configured to provide a first view of the choreography model, the first view including first constructs that are associated with a first sequence degree characterizing a degree to which a sequence of the interactions between the entities is provided, a second choreography modeler configured to provide a second view of the choreography model, the second view including second constructs that are associated with a second sequence degree characterizing the degree to which the sequence of the interactions between the entities is provided, and a choreography mapper configured to relate the first view to the second view, and configured to relate the first constructs to the second constructs.

According to another general aspect, a system may include a choreography manager configured to manage a choreography model governing interactions between at least two entities. The choreography manager may include a first choreography modeler configured to provide a first view of the choreography model, the first view including entity-based constructs representing at least one of the entities, a second choreography modeler configured to provide a second view of the choreography model, the second view including action-based constructs representing actions taken by at least one of the entities during execution of the choreography model, and a choreography mapper configured to relate the first view to the second view, and configured to relate the entity-based constructs to the action-based constructs.

According to another general aspect, a method may include determining one or more of a domain view and a role-based view of a choreography model governing interactions between at least two entities, determining one or more of a milestone view and a scenario view, relating one or more of the domain view and the role-based view to one or more of the milestone view and the scenario view, and providing the choreography model, based on the relating.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for providing multi-staged and multi-viewpoint choreography models.

FIG. 2 is a flowchart illustrating an example implementation of the system of FIG. 1.

FIGS. 3A-3D are block diagrams of example choreography views that may be used by the system of FIG. 1.

FIG. 4 is a block diagram illustrating additional examples of choreography modelers of the system of FIG. 1 that may be used to produce the choreography views of FIGS. 3A-3D.

FIG. 5 is a flowchart illustrating example implementations of the system of FIG. 1 using the choreography modelers and associated views of FIGS. 3A-3D and 4.

FIG. 6 is a block diagram of an example choreography model illustrating example views of the systems of FIGS. 1 and 4.

FIG. 7 is a block diagram of the example choreography model of FIG. 6, illustrating additional example views.

FIG. 8 is a block diagram of the example choreography model of FIGS. 6 and 7, illustrating additional example views.

FIG. 9 is a flowchart illustrating a first consistency check that may be performed for the systems of FIGS. 1 and 4.

FIG. 10 is a flowchart illustrating a second consistency check that may be performed for the systems of FIGS. 1 and 4.

### DETAILED DESCRIPTION

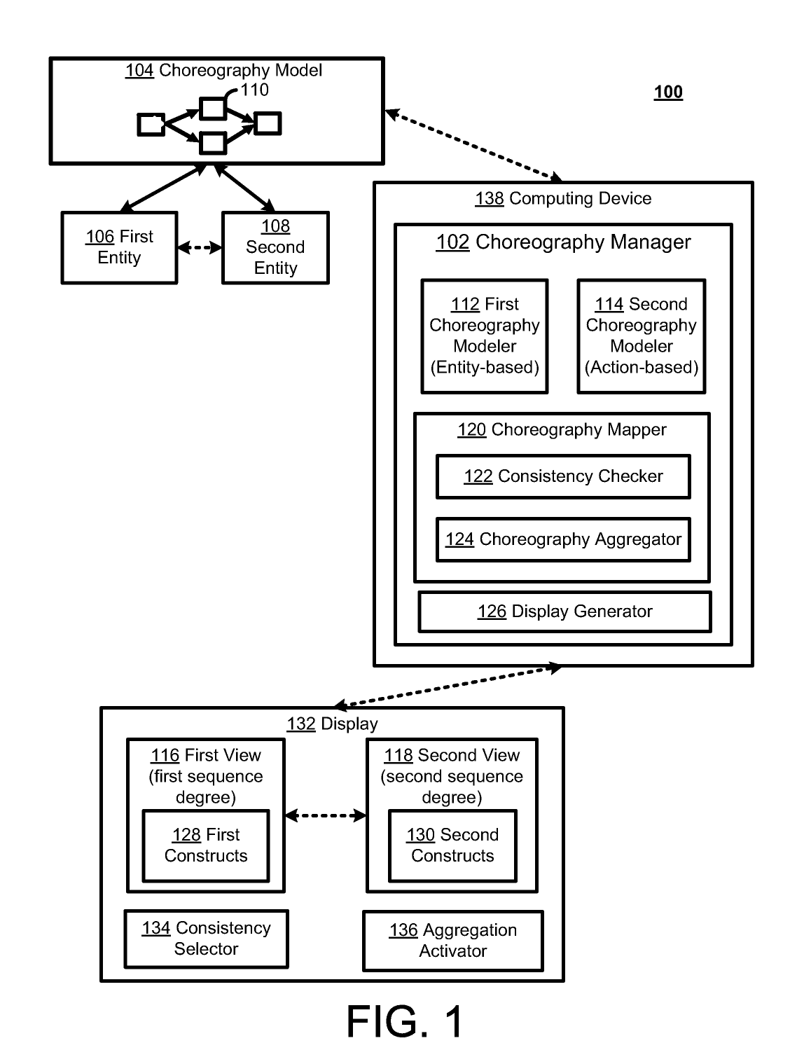

FIG. 1 is a block diagram of a system 100 for providing multi-staged and multi-viewpoint choreography models. In the example of FIG. 1, a choreography manager 102 provides for straight-forward, efficient, and flexible techniques to design, understand, implement, and modify choreography models, such as a choreography model 104. More particularly, for example, the choreography manager 102 allows for the development of the choreography model 104 using a plurality of inter-related stages, where each stage is associated with a corresponding view of the choreography model 104. By providing development of the choreography model 104 using the various stages and views, the choreography manager 102 allows a designer to select and use a stage/view that is appropriate to a current point in the lifecycle of the choreography model 104 (e.g., appropriate for an early stage of development of the choreography model 104, or appropriate for making an addition or modification to an already-deployed choreography model). Moreover, the choreography manager 102 may provide relationships between the various views, across varying layers of abstraction of the views, so that the views are consistent with one another in their representation of the choreography model 104, and are easily selectable and viewable by the designer or other user.

In the present description, examples of the choreography model 104 are primarily given in terms of interacting business partners (e.g., entities 106, 108 of FIG. 1), which may be associated with software services that are available over a network, so that the choreography model 104 represents a global model that contemplates message interactions between such services to achieve a desired, composite effect. Although further details and examples are provided below in this regard, it will be appreciated that such examples are merely for the sake of illustration, and are not intended to be limiting or exhaustive. For example, the choreography model 104 may be used to govern or define actions of (and interactions between) sensors, actuators, or other pieces of hardware that may represent, or otherwise be associated with, the interacting entities 106, 108. Additionally, even in the context of business process modeling, the term business process should be interpreted broadly as including any process that is used in profit generation of some sort, and also may refer to non-profit endeavors as well, including governmental entities, schools, churches, charities, hospitals, or virtually any other organization or entity.

When the choreography model 104 is used in the specific example of business process modeling, the focus is generally on the collaboration between the partners (e.g., the entities 106, 108), rather than on detailed descriptions of individual processes of each partner. Specifically, such collaboration may include exchanges of messages or documents in a sequenced or orderly fashion (for example, a purchase order message must precede a shipment confirmation). Similarly, the entities 106, 108 may use the choreography model 104, for example, to make pre-arrangements regarding their interactions with one another (e.g., arrangements governing messages, message formats, or message types). The interactions may be captured and expressed as part of a series of tasks or actions, illustrated as actions 110 in the conceptualization of the choreography model 104 of FIG. 1.

As referenced above, the entities 106, 108 may participate in the choreography model 104 using software services, e.g., applications having one or more specific functionalities that are exposed to other applications, often over a network (e.g., the Internet) by way of a service interface (where an operation and use of the interface may be known or determined, as needed). When such a service (and/or an interface of the service) is exposed/available over the World Wide Web (referred to herein as the WWW or the web), then the service may be known as a web service. For example, such services may provide virtually any functionality that may be provided by an application over a network, including, for instance, providing stock quotes, providing airline or other reservations, providing purchasing/invoicing functionalities, or providing some aspect of supply chain management or inventory control.

Generally speaking, the use of such services and service interactions to implement local process or orchestration models may be referred to as a service-oriented architecture (SOA), and processes that rely on services to realize process steps may themselves be deployed and accessed as services, which may be referred to as process-based service composition. Languages exist, such as, for example, the Business Process Execution Language (BPEL), that are designed to provide such compositions of services (e.g., web services), and thus provide a top-down, process-oriented approach to the SOA. Accordingly, BPEL or other such languages (such as, for example, the Web Services Flow Language (WSFL), the eXtensible language (XLANG), and/or the Business Process Modeling Language (BPML)), or modifications/extensions thereof, may be used.

In the specific setting of choreography modeling, languages using Unified Modeling Language (UML) activity diagrams and Business Process Modelling Notation (BPMN) may provide support for choreography modeling. Further, languages such as the Business Process Service Schema (BPSS) and Web-Services Choreography Description Language (WS-CDL) also may be used, and may provide support for developing, and ultimately deploying, the choreography model 104. Additionally, or alternatively, the choreography modeling language Let's Dance may be used to design the choreography model 104, particularly at early stages of development thereof, whereupon, for example, WS-CDL may be used as an implementation language for a model constructed using Let's Dance.

They system 100 of FIG. 1 and the choreography manager 102, as referenced above, allows the referenced choreography modeling languages, and other languages, to be used to develop multiples stages or views of the choreography model 104. As described in detail herein, the different views may each emphasize different aspects and details of the choreography model 104, so that one view may therefore be more useful in a particular context than another view. For example, some views may be particularly conducive to an early stage of choreography modeling, when partners may only be partially known and message interactions either can not or should not be specifically defined. Meanwhile, other views may be conducive to capturing detailed message interactions of the partners (e.g., the entities 106, 108), in a manner that may be overly-detailed for earlier stage(s) of development. Similarly, some views may be of particular interest to a business executive or other user interested in an abstracted view, while other views may be most useful to a software developer interested in specific interactions to be coded. Although the various stages and views may thus each be most useful in a particular context(s), all of the stages and views may be related to one another (e.g., may be maintained in consistency with one another, may be linked to one another, and/or may be aggregated to form a composite or complete choreography model).

Thus, in FIG. 1, the choreography manager 102 includes a first choreography modeler 112 and a second choreography modeler 114, which may be used to determine a first view 116 and a second view 118, respectively, of the choreography model 104 being developed. In this regard, it will be appreciated that the terms view, viewpoint, stage, model, and similar terminology may be used to reference the different views 116, 118, but in general, as referenced herein, the views 116, 118 provide different advantages and features relative to one another, in terms of developing and deploying the choreography model 104.

For example, in FIG. 1, the first choreography modeler 112 is illustrated as being an “entity-based” modeler. As described and illustrated in various examples herein, such models generally refer to views in which constructs of the view(s) include, or are based on, aspects of one or more of the entities 106, 108. For example, the first choreography modeler 112 may include role-based constructs, in which different roles of the first entity 106 are illustrated (e.g., the first entity 106 may have the role of purchaser in one context and retailer in another context). Generally, then, this is in contrast to conventional choreography models, in which the constructs include tasks, interactions, or other actions that may be performed by the entities 106, 108.

Conversely, then, the second choreography modeler 114 may be an “action-based” modeler, in which models or views are represented as including action-based constructs associated with actions performed by the entities 106, 108 (such as exchanging messages). Thus, for example, the second choreography modeler 114 may provide conventional interaction views, or may include a milestone model or view, in which major points of progress of the choreography model 104 are illustrated using milestone constructs, while omitting a layer of detail regarding interactions that may occur between the milestone constructs. Of course, the characterization of the first view as “entity-based” and of the second view as “action-based” should not imply that the entity-based view may not include some action-based constructs (and vice-versa).

As referenced above, many of the difficulties in designing and implementing the choreography model 104 relate to the fact that a final version of the choreography model 104 may be highly-ordered or extensively sequenced, as described, in order to capture the various inter-dependencies between the entities 106, 108 (and other entities, not shown in FIG. 1 for the sake of clarity). Failure to capture this order or sequencing correctly may result in a number of potential difficulties, such as erroneous service invocations, deadlock of the model, or other exceptions that may occur. As a result, due care should be taken to determine correct sequences of interaction, in order to guard against these and other bad results. On the other hand, determining and documenting these interactions is time-consuming and prone to error, and, even if initially correct, may be rendered moot if the designed choreography model is later modified or developed.

Thus, in the example of FIG. 1, the first view 116 may be associated with little or no order or sequencing of the constructs of the first view 116 (e.g., role-based constructs, as referenced above). For example, as an entity-based model or view, the first view 116 may simply include an identification of the entities 106, 108, and/or information characterizing some or all of the entities 106, 108, without specifying an order of interactions there between. For example, as described herein, the first view may include a domain or domain-based view, in which functions or aspects of the entities 106, 108 are identified and included in the first view 116. The domain(s) may include an entire entity, or portions of the entity (e.g., an organizational structure of the entity). Meanwhile, the second view 118 may be highly-ordered or sequenced, such as when the second view 118 includes detailed interaction patterns or scenarios between the entities 106, 108 (e.g., an availability request for an item for sale from the first entity 106 to the second entity 108, followed by confirmation of availability in the other direction, followed by a purchase request from the first entity 106 to the second entity 108, followed by a shipment from the second entity 108 to the first entity 106).

Thus, the first view 116 may be said to have a first sequence degree that is low relative to a second sequence degree of the second view 118. In this context, the term sequence degree does not refer just to a serial ordering of a plurality of actions or other constructs within the views 116, 118, but rather more generally refers to a degree or amount of virtually any ordering that is present in the views 116, 118. For example, the second view 118 may specify that the first entity 106 and the second entity 108 execute a plurality of message exchanges in parallel with one another (such as when the first entity 106 sends a plurality of availability requests for alternative items to the second entity 108, and receives responses in parallel, as well). Meanwhile, the first view 116 may capture or reference the same message exchange(s) simply to the level of specifying that the first entity 106 and the second entity are expected to exchange messages, or are expected to exchanges messages of a type related to requests for availability.

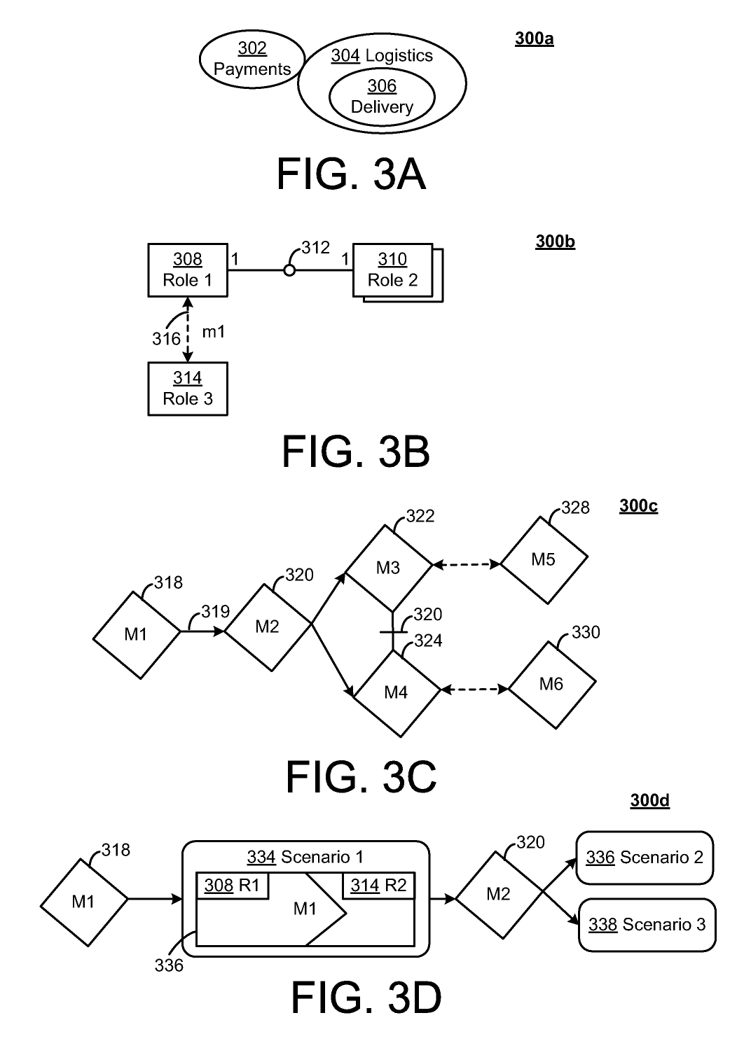

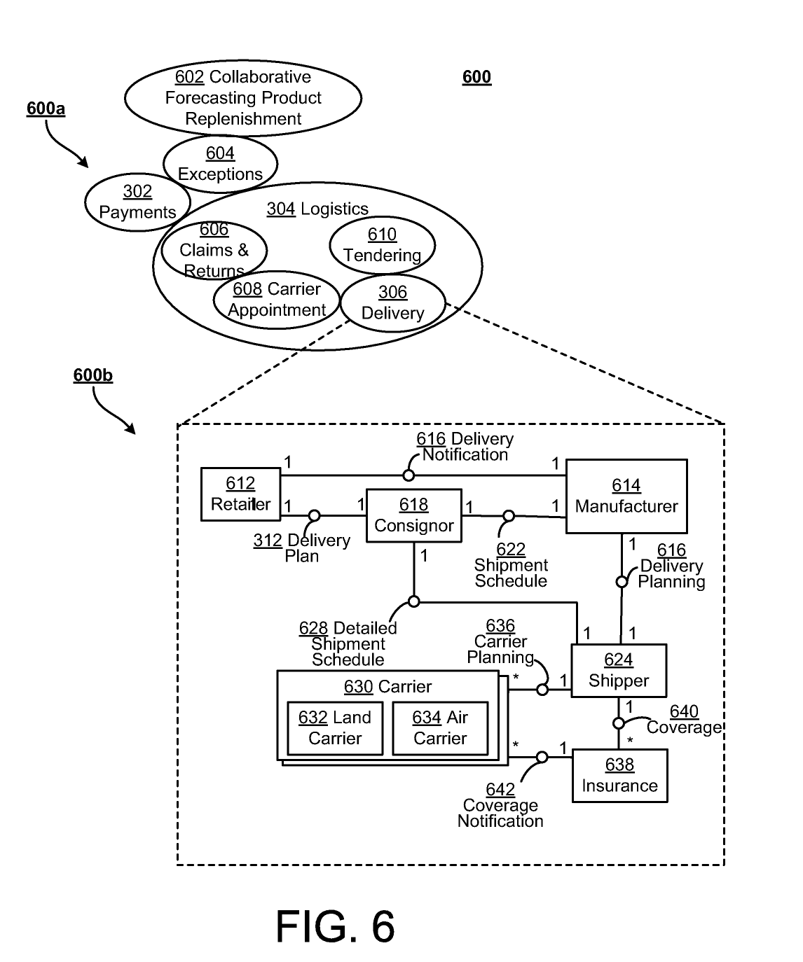

When the first view 116 is associated with the entity-based view of the first choreography modeler 112, the first sequence degree may be considered to effectively be zero, so that no express or implied ordering is provided. For example, if the first view 116 includes a role-based view in which roles of the entities 106, 108 are specified, then a plurality of communication channels between the roles may be defined, without specifying any order of messages sent over such channels (as described in more detail below, e.g., with respect to FIG. 3B and FIG. 6.

Although the example of FIG. 1 illustrates a first, entity-based choreography modeler 112, it may be appreciated that the choreography manager 102 may include multiple entity-based modelers, e.g., to provide both of the domain view and the role-based view referenced above. Similarly, a plurality of action-based choreography modelers may be included, rather than the single action-based choreography modeler 114 of FIG. 1, e.g., to provide both the milestone view and the scenario/interaction view(s) referenced above. Moreover, combinations of entity-based and action-based views may be constructed, and all views may have varying sequence degrees ranging from zero to fully-sequenced (e.g., ready for use/deployment). For example, the milestone view (in which only major points of progress are included) may include an overall order or progression, without fully expressing the order of message interactions that would be expected for the executable or quasi-executable form of the choreography model 104.

A choreography mapper 120 may be provided to map or otherwise relate the views 116, 118 (and other views) to one another. For example, a particular entity (or entity-related construct) of the first view 116 may be associated with an instance of the second view 118. For example, a domain view as the first view 116 may include a particular domain that is associated with a milestone view as the second view 118. For example, for a delivery domain, there may be a milestone view including milestones for selecting a carrier and scheduling the delivery. Further examples and details of how the choreography mapper 120 may relate the views 116, 118 are provided herein.

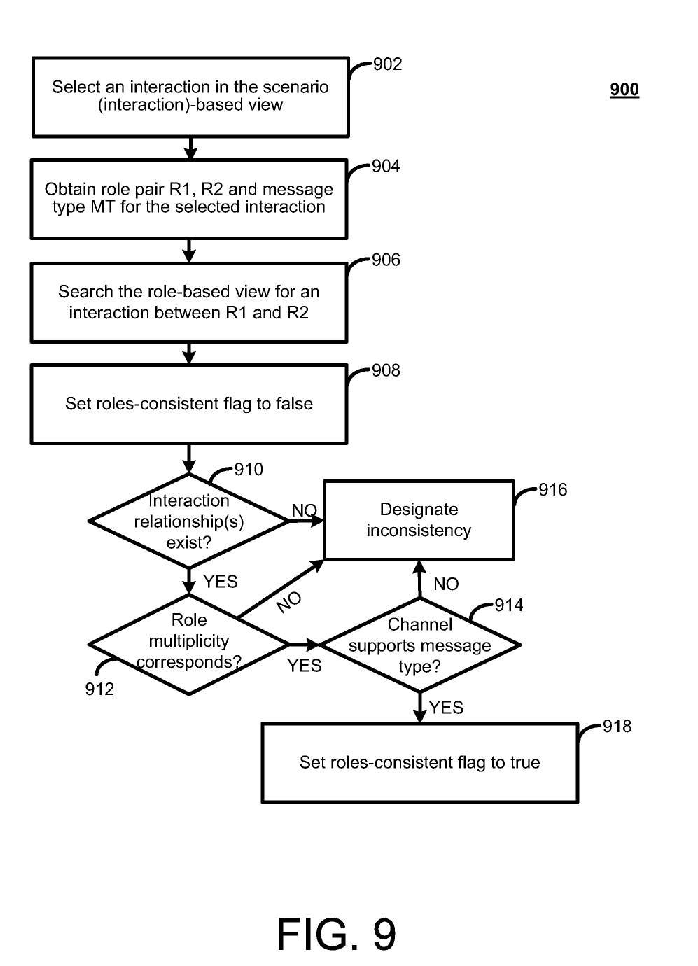

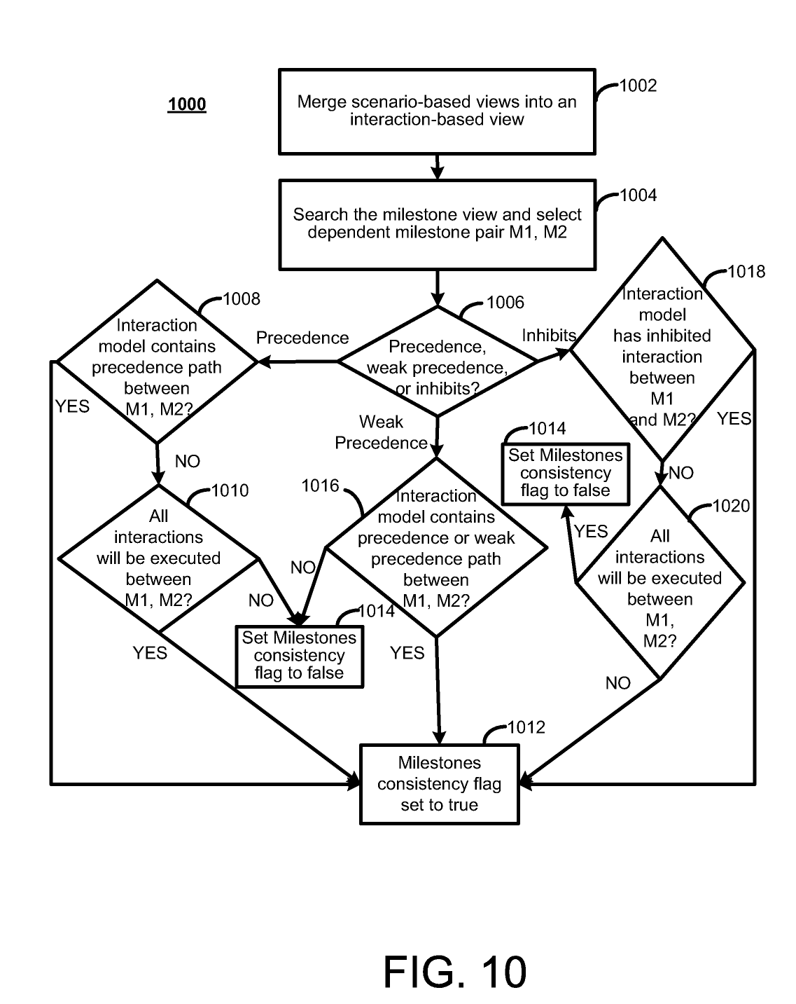

For example, a consistency checker 122 may be used to ensure a desired level of consistency between the views 116, 118. Detailed examples for performing such consistency checks are provided herein (e.g., with respect to FIGS. 9 and 10). In general, however, it may be appreciated as an example of impermissible inconsistency that a particular message interaction should not be required in one view but prohibited in another. As another example, if a message is sent in an action-based view as originating from a particular source, then that source may be required to be present in an entity-based view (e.g., as a role of the first entity 106).

The choreography mapper 120 also may include a choreography aggregator 124, which may be configured to aggregate or otherwise combine one or more of the views 116, 118 to obtain the choreography model 104 for execution thereof, while retaining the various views and relationships therebetween (e.g., for use by designers in understanding or modifying the choreography model 104). For example, in a case where both a milestone view and an interaction view are present, then the choreography aggregator 124 may be used to insert some or all of the interaction view within and between milestones of the milestone view.

Further, the choreography manager 102 may include a display generator 126 that is configured to receive an output of the first choreography modeler 112, the second choreography modeler 114, and the choreography mapper 120, and configured thereafter to display first constructs 128 and second constructs 130 of the first and second views 116, 118, respectively, on a display 132. For example, where the first view 116 includes a role-based view, then the first constructs 128 may be role-based constructs, such as block identifying each role of the entities 106, 108. Similarly, where the second view 118 includes a milestone view, then the second constructs 130 may be a designated shape associated with illustrating milestones.

The views 116, 118 may be provided in juxtaposition with one another on a single screen of the display 132 (perhaps with an illustration of the relationship between the views 116, 118), or may be selectable for individual viewing and modification. The display generator 126 may receive a selection of all or part of a view being displayed, and may determine from the choreography mapper 120 whether and how to display a corresponding or related portion of another view (e.g., may receive a selection of a domain of a domain view, and provide a corresponding milestone view in response).

The display generator 126 also may provide a consistency selector 134 and an aggregation activator 136. The consistency selector 134 and the aggregation activator 136 may be provided by simply providing one or more selectable icons for the display 132. For example, selecting the consistency selector 134 in one embodiment may automatically provide consistency checking for all available views, while in another example embodiment the consistency selector 134 may be used to perform more selective or specialized consistency checking (e.g., checking consistency between some sub-set of available views, or only checking consistency in a uni-directional manner between two specified views). Similar comments may apply to the aggregation activator 136, which may be used to perform all-inclusive aggregations using the choreography aggregator 124, or which may be used to perform incremental or selected aggregations.

The display 132 may be associated with a computing device 138 as either a local computing device or a remote computing device accessed over a network. The choreography manager 102 may thus be implemented as part of a process modeling suite, e.g., using an enterprise application server, that may include various other conventional functionalities that are not described herein in detail (e.g., orchestration engines and messaging infrastructures). One or more of the entities 106, 108 may be responsible for implementing the choreography manager 102, in collaboration with one another, so that the entities 106, 108 may create versions of the views 116, 118 that may need to be merged or synchronized with one another.

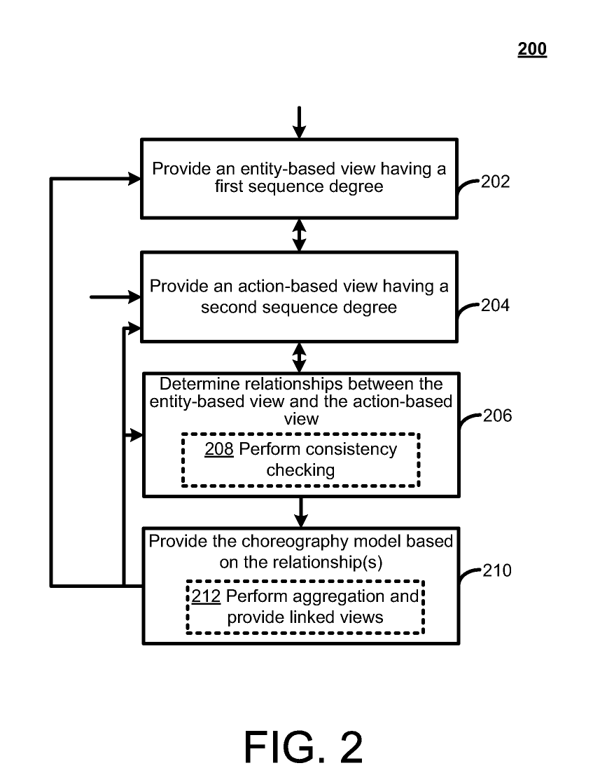

FIG. 2 is a flowchart 200 illustrating an example implementation of the system of FIG. 1. In the example of FIG. 2, an entity-based view may be provided having a first sequence degree (202). For example, the first choreography modeler 112 may be used to provide the first view 116, and/or another entity-based view, as described above. An action-based view having a second sequence degree may be provided (204). For example, the second choreography modeler 114 may be used to provide the second view 118, and/or another action-based view, as described above.

In general, it may be appreciated that entity-based views may be associated with lower sequence degrees than action-based views. Consequently, entity-based views may be associated with high-level or early stage development of the choreography model 104, where it is not necessary, and indeed may be disadvantageous, to provide detailed information regarding ordering of message interactions. Therefore, in the example of FIG. 2, the flowchart 200 is illustrated as beginning with the providing of the entity-based view(s). However, it also may occur that a designer of the choreography model 104 may already know some discrete or small-scale portion of the choreography model 104, which may (in a given example) be easy and straight-forward to implement. Consequently, the flowchart 200 also may begin with the providing of the action-based view (204). In either case, development and design may continue in a parallel and/or iterative manner (e.g., the entity-based view may be developed by one party as the action-based view is developed, perhaps at the same time, by another party).

Relationships may be determined between the entity-based view and the action-based view (206). For example, the choreography mapper 120 may be used to determine a relationship between one of the first constructs 128 (e.g., a domain construct for a domain view or a role-based construct for a role-based view) and the second view 118 (e.g., a milestone view or an interaction view, respectively, as described in more detail, below. Of course, the choreography mapper 120 may determine relationships between multiple entity-based views, or multiple action-based views, as well. As part of determining the relationships, consistency checking may be performed (206) between the various views.

The choreography model may then be provided, based on the relationships (210). For example, the choreography aggregator 124 may perform aggregation of the entity-based first view 116 and the action-based second view 118, in order to determine the choreography model 104, so that linked views therebetween may be provided (212), e.g., by the display generator 126.

As shown, operations of the flowchart 200 may continue in an iterative manner. For example, a new action-based view and/or entity-based view may be provided (or an existing view modified) even after consistency checking and/or aggregation have been performed. The nature of the iterative operations of the flowchart 200 is provided by the feedback loops of FIG. 2, however, the order and operation of the operations 202-210 is not intended to be exhaustive or limiting.

FIGS. 3A-3D are block diagrams 300a-300d, respectively, of example choreography views that may be used by the system 100 of FIG. 1. More specifically, FIGS. 3A-3D illustrate an example domain view 300a, an example role-based view 300b, an example milestone view 300c, and an example scenario view 300d. In the example of FIGS. 3A-3D and in various following examples, the choreography model 104 is described in a setting related to a sales and logistics component of the Electronic Data Interchange (EDI) framework standard of the Voluntary Interindustry commerce solutions (VICS), which utilizes a range of entities participating in long-running collaborations through well-defined messaging interactions, and causal dependency of interactions requiring visibility by many or all of the entities. More specifically, the VICS Sales and Logistics addresses global supply chains between retailers and manufacturers, covering processes where products are merchandised, stocks are replenished, and shipments are made and paid for. As may be appreciated, such shipments may need to be managed and optimized with respect to carriers crossing various local or international borders, and fulfillments of orders need to be assessed for the next cycle of merchandising and replenishment. Further, in the examples described herein, where feasible, the choreography modeling language Let's Dance is used.

Thus, with reference to FIGS. 3A, a domain (or collaborations domain) view 300a is provided as an example of the first view 116 of FIG. 1, where, as referenced above, such a domain view may provide a high level of scoping for different parts of the choreography model 104. Specifically, a payments domain 302 is illustrated along with a logistics domain 304, which itself contains a sub-domain, a delivery domain 306. As a simplified example, FIG. 3A illustrates that such a domain view may illustrate domains as ellipses that partition an area of analysis into one or more domains, where domains may be connected to one another to indicate the possibility of message exchanges therebetween. For example, in FIG. 3A, the domain payments 302 is illustrated as contacting the domain logistics 304, since (a portion of) an entity participating in payments may need to receive a message regarding, for example, receipt of a delivery that occurs in the domain delivery 306.

Domains views may be considered to be entity-based in the sense that portions of entities 106, 108 may be defined to be within one or more domains. For example, organizational artifacts or groups within the entity 106 (e.g., an enterprise or company) may be used to define domains, such as organizational units, business policies, or functional groups within an enterprise (e.g., a payroll processing group or human resources group). Of course, new domains may be defined with respect to one or more of the entities 106, 108, which may be useful to the choreography model 104, even if a corresponding group does not already exist in an organizational structure of the entities 106, 108. Further, a single domain may span two or more participating entities, e.g., where two entities share or coordinate actions within a particular domain.

Thus, in the example of FIGS. 3a-3D, domain views generally provide the highest level of scoping for different parts of the choreography model 104. For example, in the global supply chain example just referenced, the collaboration landscape may be complex with many (tens to hundreds) stakeholders (entities) involved in a variety of functional aspects (e.g., product mechanizing, collaborative forecasting product planning, delivery and payments). Current choreography modeling languages may not cater for different functional contexts in which the same sets of entities collaborate, but rather tend to work off the same context. As a result, and particularly for enterprises or other entities which involve multiple contexts, the choreography models developed through these languages become convoluted. Domain views may thus be used to provide a partitioned scope(s) that may be easily aligned with organizational phenomenon such as organizational structures.

More detailed examples of domain views are provided below, but in general from FIG. 3A it may be appreciated that domain views may be particularly useful in early-stage or high-level modeling, when participant entities are fluid with respect to identity and inclusion/exclusion. As such, example lines of analysis for domain-based views of choreography models may involve broad tactical operations and risk mitigation. For example, consideration may be made as to which functional areas of partner organizations (e.g., entities) may be covered, and to any risk of their inclusion (or non-inclusion). Consideration may be made as to what part(s) of the value-chain are (are not) integrated into the overall coordination of operations. Different systems that may be involved may be considered, along with an overall expected quality of operations (e.g. redundancies, bottlenecks, disconnects). It may be determined which partners are (or are not) involved in different parts of coordination (e.g. product merchandizing, delivery). Specific scenarios or interactions within a particular functional area(s) may be identified, and restructuring may be considered without undue impact on the current view.

In practice, an enterprise project (e.g., a supermarket supply chain) may be assigned a set of domains (e.g. product merchandizing, delivery), such as the set of domains 302-306 of FIG. 3A. As referenced, a domain includes a functional scope that is associated with choreography models. The domain may be associated with a name, a functional description, a version and a status indicating its status of development. Domain status in this context may include a state of synchronization (referring to whether all domains have been developed, tested and synchronized in the enterprise project; otherwise the domain view may be considered unsynchronized, meaning that the models of the domain are still under development and have not been synchronized into the enterprise project.

A domain may (recursively) consist of sub-domains to allow for arbitrarily complex domains (as seen with respect to the domain delivery 306, and as seen in more detail in FIG. 6, below). As also shown in more detail below, each domain (or at least a lowest-level domain within a set of domains) may be associated with one or more other choreography views. For example, the domain delivery 306 may be associated with a role-based view in which the participants and roles of the entities 106, 108 playing a part in deliveries are illustrated and characterized.

FIG. 3B illustrates a role-based view 300b in which a first role 308 (e.g., a retailer) may communicate with a second role 310 (e.g., a manufacturer) by way of a communications channel 312. Similarly, the first role 308 may communicate with a third role (e.g., a consignee) by way of a communications channel 316.

Role-based views may thus provide the highest level of choreography viewpoint within a particular domain, as shown with respect to FIG. 6. In the example of a global supply chain provided herein, and similar examples in which many stakeholder entities may be involved in a wide spectrum of functional areas of collaboration, the role-based view 300b provides a useful viewpoint for focusing on the roles and their interaction relationships of a specific domain (e.g. roles and their interactions in collaborative forecasting product planning).

Thus, as opposed to including only a single context in which collaborations between partner entities is illustrated using actual interactions therebetween, the role-based view 300b provides information regarding interaction relationships, rather than actual interactions. That is, as shown, the channel 312 may merely indicate that the roles 308, 310 may have some need (and some ability) to communicate with one another, without specifying exactly when, whether, or how such interactions may occur. For example, retailers and manufacturers may need to communicate, but in a role-based view, such communication may be characterized as the communication channel 312, without providing implementation details or mechanisms (e.g., message queues, ports, email boxes) that may need to be specified at a later stage of design.

Thus, as with the domain view 300a, the role-based view 300b provides an example of the first (entity-based) view 116, which may be suitable for relatively early stages of development and design of the choreography model 104. Also similarly to the domain view 300a, which includes domain constructs, by including the first constructs 128 as role-based constructs, the role-based view 300b allows for the removal of virtually any implication or representation of sequencing or ordering message interactions, and, consequently, (in the terminology of FIG. 1) may be said to have a very low (or zero) sequence degree. Instead, a designer may focus on a broad operational understanding of coordination centered on the partner entities that are involved, e.g., which roles are involved in a functional area, and whether/when the key scenarios and their milestones may be reached. Interaction relationships may be identified without being fully specified, and the impact of restructuring coordination (e.g., adding or removing roles, or requiring that some roles take on more or less responsibility) also may be considered.

Thus, in FIG. 3B, and in following examples, role-based views may include channels (such as the channels 312, 316) which represent an interaction relationship and which may have a name(s) and a functional description(s). A channel such as the channels 312, 316 may be characterized as permitting a set of message types to be passed thereover, and which role sends the message, with the assumption that an appropriate set of data identifiers may be used to correlate messages with corresponding instances of the choreography model 104.

In the examples described herein, role-based views include boxes representing the roles in question, connected by lines with holes where the holes represent the corresponding channel(s) between connected boxes (roles). The lines (channels) may be designated as a one-to-one interaction relationship (shown by the numeral “1”s in FIG. 3B), or may be designated as one-to-many or many-to-many, as described below with respect to FIG. 6, such as when a company issues a tender by multicast to multiple suppliers. Some roles may appear in different domains, and in some examples, the same role may interact with other roles in different cardinalities when in one domain as opposed to another domain.

A role may be aggregated from more than one role type, so that, for example, interactions may be related to the aggregated role, with a deferred selection of which of the constituent roles will actually be involved. In these examples, a designer or modeler may specify rules which are used as the basis for determining such a selection. For example, the role of consignee may be used to aggregate roles such as “distribution center” and “store,” so that interactions may occur with, or between, any of these roles. Somewhat similarly, a role may be specialized into more than role (e.g., a carrier may be a Land Carrier, Rail Carrier, Ocean Carrier or Air Carrier, where such sub-roles may carry the same interaction relationships as the super-role, as well as further interactions.

Similarly with domains, roles may be associated with modeled artifacts of organizations, such as organizational units, business policies, and responsible organizational actors. Channels may be associated with implementation-oriented configurations, such as, for example, BPEL partner links.

Considering the domain view 300a and the role-based view 300b, and as described in more detail below with respect to FIG. 6, the role-based view 300b may be associated with a domain of the domain view 300a, and directly viewable therethrough. In the domain view 300a, a domain may be considered to be related to another domain (and therefore illustrated as being in contact with the other domain) if there is at least one role in each which interacts with one another.

FIG. 3C illustrates a milestone model or milestone view 300c. As just discussed, both the domain view 300a and the role-based view 300b may be considered to be entity-based views, whereas the milestone view 300c is an example of an action-based view. That is, the milestone view 300c may be used to provide the highest level of choreography viewpoint within a particular domain from a behavioral perspective. Thus, domain view 300a or role-based view 300b capture what domains or roles are involved and their interaction relationships, which are structural considerations only and reveal little or nothing about the sequencing order of interactions (i.e., have relative low sequence degrees). In contrast, the milestone view 300c provides interaction sequencing and thus has a higher sequence degree. However, the milestone view 300c includes such sequencing only to the extent of capturing “signposts” or major points of progress within the choreography model 104 that interactions should reach. Use of the milestone view 300c allows designers to specify different solutions for choreographed interactions, provided that the interactions accord to the required milestones (as illustrated below with respect to FIG. 3D and FIGS. 7 and 8.

In the example of FIG. 3C, the milestone view 300c includes a first milestone construct 318 with a connector 319 to a second milestone construct 320. As shown, milestone constructs 322, 324 are illustrated as being in parallel with one another, one of which is allowed to proceed as specified by a connector 326, to allow one or the other (but not both) of milestone constructs 328, 330 to execute.

More specifically, the connector 319 may be referred to as a “precedes” or “precedence” or “strong precedes” connector, in which a first milestone (represented by the milestone construct 318) must complete execution before a second milestone (here, the milestone represented by the milestone construct 320) may begin execution. Meanwhile, the connector 326 may be known as an inhibitor, which, as referenced above, acts to prevent one milestone from being reached once another milestone is reached (e.g., in FIG. 3C, if the milestone 322 is reached so that the milestone 328 executes, then the inhibitor 326 ensures that the milestone 324 does not execute, so that the milestone 330 is never reached. Finally, connectors 332 are examples of “weak precedes” or “weak precedence” connectors, which allows one milestone to be reached only after another milestone has been reached or skipped (that is, if an earlier milestone weakly precedes a later milestone, then the earlier milestone may or may not execute (i.e. the earlier milestone may have been inhibited) before the later one begins execution).

Milestone analysis may be performed after, or in conjunction with, domains and roles have been identified and expressed. Typical lines of analysis for milestone-based models or views may involve a broad operational understanding of coordination, centered on major points of progress. For example, milestones involved in a functional area may be identified, along with their ordering dependencies. Aspects of collaboration between partners which relate to achieving milestones may be identified, and coordination of milestones may be structured to optimize efficiency.

In the examples provided herein, and as shown in FIG. 3C, milestones may be illustrated as diamonds connected by solid lines (for precedes/strong precedes relationships), crossed lines (for inhibition relationships), and dashed lines (for weak precedence relationships). Precedence relationships may apply for pairs of milestones fundamentally, (precedence between defined sets or groups of milestones can be reduced to precedence between the different pairs of milestones). Each milestone may be given a name and a functional description. A milestone view may have a one-to-one association with a domain construct of a domain view, and may be associated with one or more roles (so that when a milestone is reached, the associated role(s) may be identified of this progress).

Analogously to domain views and role-based views, the milestone view 300c may be related to modeled artifacts of organization(s), such as, for example, detailed goals, objectives, or policy outcomes. Milestone views may be implemented in conjunction with implementation-oriented configurations/models, e.g., as specially-designated tasks/events. For example, such tasks/events may occur at major points of synchronization, and may be visible as such to users of the choreography model 104 and associated milestone view 300c.

FIG. 3D illustrates a scenario-based view 300d. In the example of FIG. 3D, a scenario 332 is illustrated as occurring between milestones 318 and 320, and scenarios 336 and 338 are illustrated as occurring after the milestone 320 (but before the milestones 322, 324 (not shown in FIG. 3D). Each scenario may be considered as a series of one or more interactions that are grouped together to obtain some localized or discrete result. For example, the scenario 332 is illustrated as including an interaction 336, in which the role 308 sends a message “m1” to the role 314.

Thus, such views may be referenced as scenario-based views, or in some cases, may simply be referred to as interaction-based views. Such views provide detailed interactions of the choreography model 104, in which interactions capture message exchanges between roles, as shown in the interaction 336. That is, as shown, an elementary interaction captures a message exchange between a role sending a message of a type and another role receiving a message of the type. The interaction may be considered atomic, and is modeled as a single construct (much like a task in a classical process modeling language). There are different elementary interactions that are defined in more detail in the language Let's Dance or other suitable language (with support from Business Process Modelling Notation (BPMN) or other design languages). For example, interactions may be defined as: normal, guarded, and repeated interactions (while, repeat, for each (sequential), and for each (concurrent)). Multi-cast interactions (e.g. a message sent to multiple receivers) may be modeled through repeated interactions. Such interaction patterns are defined fully in the context of the language Let's Dance, which is merely one example of a language for supporting interaction-based choreography models.

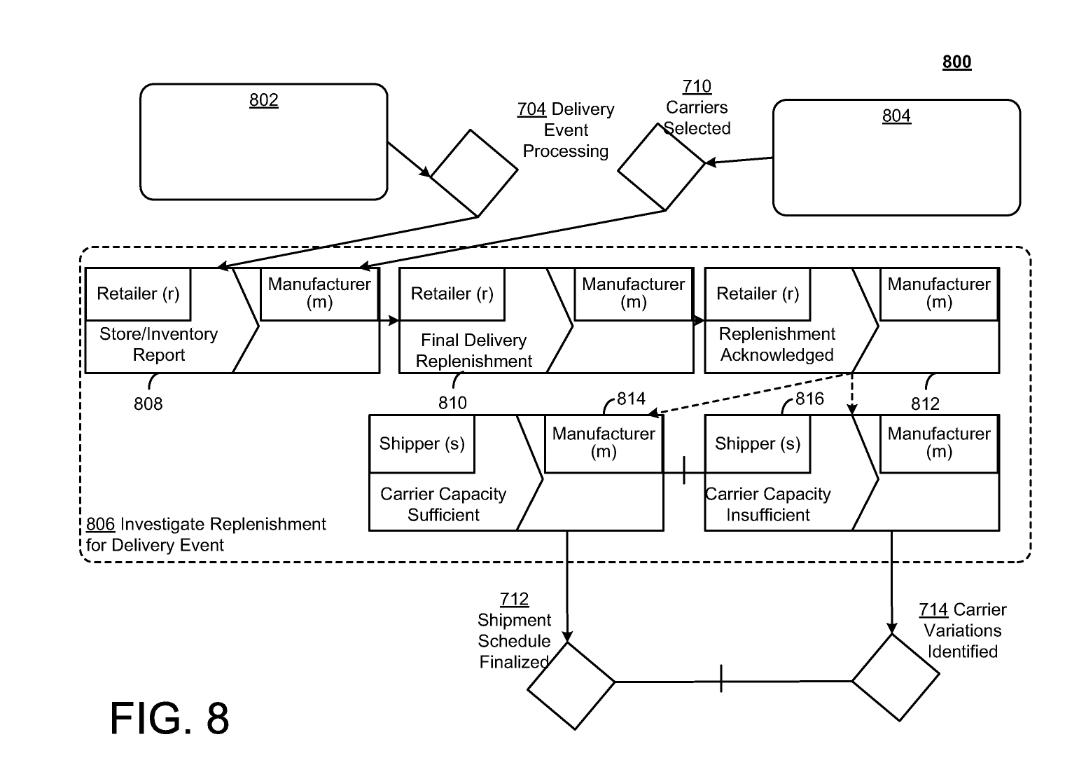

Choreography models may thus be portioned into individual, use-case focused models, e.g., scenario-based views in which each scenario contains a set of interactions. Then, as shown in FIG. 3D and described in detail below with respect to FIG. 8, milestone models may be used to tie the scenario views together with one another (e.g., scenarios may be inserted between milestones, as shown).

An elementary interaction within a scenario may have a name, an optional description and a type (e.g., basic, guarded, repeated, or composite). An elementary interaction generally has a sender, a receiver and a message to be exchanged. Guarded and repeated interactions have conditions attached to them, and execution depends on satisfaction of those conditions. Interactions have dependencies between them signifying allowable execution order. As discussed with milestone views, above, such dependencies may be characterized as (strong) precedence, weak precedence and inhibition.

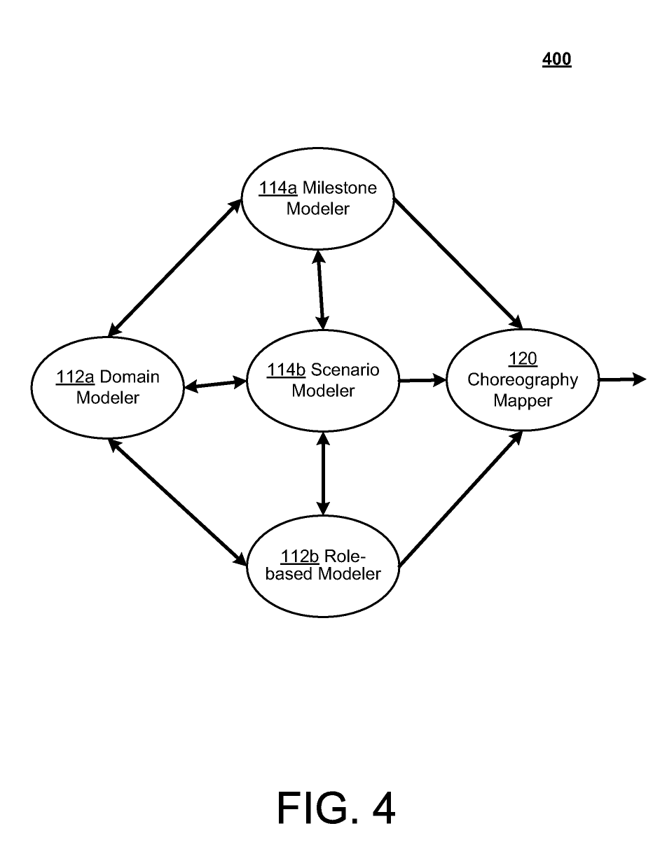

FIG. 4 is a block diagram 400 illustrating additional examples of choreography modelers 112, 114 of the system of FIG. 1 that may be used to produce the choreography views 300a-300d of FIGS. 3A-3D. More specifically, a domain modeler 112a and a role-based modeler 112b represent examples of the first choreography modeler 112, e.g., an entity-based modeler, while a milestone modeler 114a and a scenario-based (or interaction-based) modeler 114b provide examples of the second choreography modeler 114, e.g., an action-based modeler. More specifically, as described herein, the modeler 114b of FIG. 4 may represent either or both of a scenario-based modeler or an interaction-based modeler, where the interaction-based modeler represents (or is associated with) an aggregation of two or more synchronized scenario-based models.

FIG. 4 generally illustrates an overall left-to-right flow from early-stage domain modeling to ultimate relating, aggregating, and producing of the final choreography model 104 by the choreography mapper 120. As shown, however, and as described with reference to FIG. 2, construction of the various views may occur in any number of orders, and may occur iteratively or in parallel, as well.

For example, scenario-based views may be developed simultaneously as domain views. Milestone views may be developed before or after development of the scenario-based views, and, as shown in FIGS. 3D and 8, scenario-based views may be fitted in between the various milestones. Role-based views may be implemented by the role-based modeler 112b as including identification of specific participant entities 106, 108, as well as identification of specific message types (or other message characteristics).

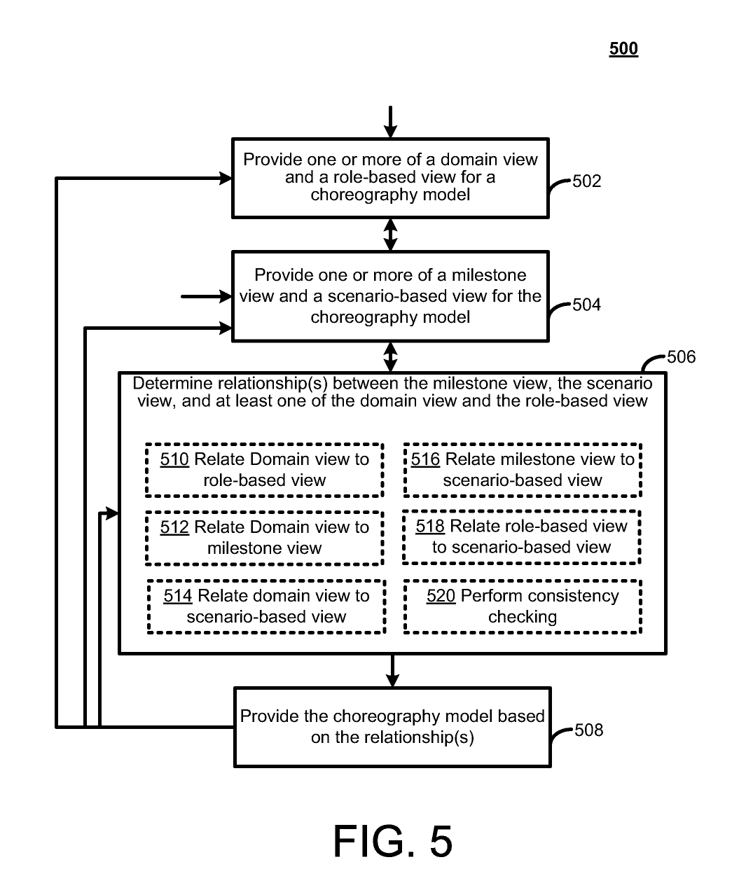

FIG. 5 is a flowchart 500 illustrating example implementations of the system of FIG. 1 using the choreography modelers and associated views of FIGS. 3A-3D and 4. FIG. 5 is similar to FIG. 2 in describing a progression between a plurality of stages in providing the choreography model 104, but with reference to the specific views and modelers of FIGS. 3A-3D and FIG. 4.

Thus, in FIG. 5, one or more of a domain view and a role-based view may be provided for a choreography model (502). For example, the domain modeler 112a or the role-based modeler 112b may be used, respectively. As described above, such modelers may be considered examples of entity-based modeler(s) 112, and may have a relatively low (or zero) sequence degree characterizing a sequence of interactions of constructs (e.g., domain constructs or role-based constructs) thereof.

One or more of a milestone view and a scenario-based view may be provided for the choreography model (504). For example, the milestone modeler 114a or the scenario-based modeler 114b may be used, respectively. As described above, such modelers may be considered examples of action-based modeler(s) 114, and may have a relatively high sequence degree characterizing a sequence of interactions of constructs (e.g., milestone constructs or scenario-based constructs) thereof.

As already described, an order of development of the various views may proceed in any desired order, or wholly or partially in parallel. Further, it should be apparent that not all of the available views are necessary for a given choreography model. For example, the milestone view may be omitted and the scenario-based view may simply include a plurality of interconnected scenarios/interactions, without intervening milestones. Similarly, the domain view may be omitted, and the role-based view may be the only example of an entity-based view that may be used in the design of a particular choreography model.

Relationships may be determined between the various views that are used in a given setting, e.g., between the milestone or scenario views and one or both of the domain view and the role-based view (506). For example, the choreography mapper 120 may be used to determine various relationships between the various views, as referenced above, and described in more detail, below.

In various examples, the domain view may be related to the role-based view (510), the domain view may be related to the milestone view (512), and the domain view may be related to the scenario-based view (514). Similarly, the milestone view may be related to the scenario-based view (516), the role-based view may be related to the scenario-based view (518). Examples of possible relationships between the various views are provided herein. For example, as referenced above, a domain construct of a domain view may have a one-to-one relationship with a milestone view, whereas a milestone or milestone view may be associated with a plurality of roles. As another example, scenarios may be related to milestones by splicing the scenarios between appropriate milestones.

In conjunction with, or after, the relating of the various views, consistency checking may be performed (520). For example, the consistency checker 122 may be configured to determine a global consistency of all views, perhaps in response to a selection of the consistency selector 134. In other examples, consistency checking may be more selective. For example, consistency checking may be performed between role-based and milestone views, or between role-based and scenario-based views, or between milestones and scenario-based views. Consistency may be checked bi-directionally (e.g., between each pair of views), or uni-directionally (e.g,. checking whether a second view is consistent with a first view, with regard for whether the first view is fully consistent with the second view). Further and more specific examples of consistency checking are provided below with respect to FIGS. 9 and 10.

The choreography model 104 may thus be provided based on the determined relationships (508). For example, the choreography aggregator 124 may be used to combine some or all of the various views, and the display generator 126 may be used to display the views in relation to one another on the display 132 of FIG. 1. As described, relationships between the various views may be exploited by allowing one view to be linked from (and thus viewed from) another, related view, e.g., by selecting (e.g., clicking on or zooming/folding) a particular construct of the first view.

As represented conceptually in FIG. 5, and as referenced above, iterations of the above operations may occur, as needed. For example, even after the choreography model 104 has been provided (508), views may be modified, or new views may be added, and the choreography model 104 may be updated accordingly. For example, adding a new role-based view (or new role construct) may result in a need for the milestone view to report completion of a particular milestone to the new role. Thus, changes made in one view may, through consistency checking and other relationships between views, ripple through one or more other views, so that an overall consistency and completeness of the choreography model 104 may be maintained.

FIG. 6 is a block diagram 600 of an example choreography model illustrating example views of the systems of FIGS. 1 and 4. Specifically, FIG. 6 illustrates a domain view 600a and a corresponding role-based view 600b. Building from the example domain view 300a of FIG. 3A, the domain view 600a includes constructs for the already-described payments domain 302, the logistics domain 304, and the delivery domain 306. Further, the domain view 600a includes constructs for a domain 602 for collaborative forecasting product replenishment (e.g., for predicting a need for, and ordering, new inventory), an exceptions domain 604 (e.g., for handling errors and other unexpected outcomes), a claims and returns domain 606 (e.g., for handling customer complaints and merchandise returns/exchanges), a carrier appointment domain 608 (for appointing carriers of inventory), and a tendering domain 610 (for preparing and extending offers).

As shown in the example of the logistics domain 304, domains may have various sub-domains, illustrated here as one or more additional ellipses within a particular ellipse (or other domain construct). Further, as already referenced, overlapping or other contact between domain constructs (e.g., the various ellipses) may represent a connection or possible message exchange between the connected domains. For example, the domain 602 for collaborative forecasting product replenishment (from which an order may be produced) connects with the logistics domain 304 (governing shipments of goods). Similarly, the logistics domain 304 connects with payments domain 302 and exceptions domain 604.

Similarly to the example role-based view 300b of FIG. 3B, the role-based view 600b includes role constructs illustrated as boxes (roles) connected by lines with circles (communication channels). Specifically, as shown, the role-based view 600b includes roles of retailer 612 and manufacturer 614, connected by a channel 616 for delivery notification. A consignee 618 may share a channel 620 with the retailer role 612, for communicating messages regarding a delivery plan(s). Meanwhile, the consignee 618 may share a channel 622 with the manufacturer 614 for exchanging messages about shipment schedule(s).

Further in the example of FIG. 6, a shipper 624 may share a channel 626 with the manufacturer 614, for sharing messages regarding delivery planning. Meanwhile, the shipper 624 may share a channel 628 with the consignee 618 for exchanging messages regarding a detailed shipment schedule. A role for a carrier(s) 630 includes a land carrier 632 and an air carrier 634. The shipper 624 may share a channel 636 with the carrier 630, for exchanging messages about carrier planning. Finally in the example of the role-based view 600b, an insurance role 638 may share a channel 640 with the shipper 624, regarding insurance coverage available for the shipments, while also sharing a channel 642 with the carrier 630 regarding notifications of insurance coverage.

As already described, the views 600a, 600b do not imply or include an express or implied order of interactions. Rather, the views 600a, 600b provide a generally static view of the participants and how the participants may interact with one another over a lifetime of the choreography model 104. The views 600a, 600b may be presented in a visually convenient and useful form; e.g., a user may view the role-based view 600b simply by clicking on, or otherwise selecting, the delivery domain 306 from within the display 132 of FIG. 1. Further, additional information may be provided in a similar manner. For example, a circle of one of the channels (e.g., the channel 626 for delivery planning) may be selected to view characteristics of the possible messages that may occur thereover. For example, by clicking on the circle for the channel 626, a viewer may observe information about possible message types (e.g., offer, reply, confirmation, schedule, or pricing), as well as possible directions of these messages). By including this additional information, a sequence degree of the role-based view may be considered to be raised, since there may be some indication of a direction of a message. But in general, the role-based view 600b does not imply that any such messages over a given channel should occur before or after other messages going over other channels.

Further in FIG. 6, and as referenced above, cardinality constraints on channels may be used to express how many participants of one role may interact with a participant of another role. For example, the shipper 624 may communicate with a number of carriers for carrier planning (in a given choreography instance), although a given carrier interacts with only one shipper (as shown by the designators “1” and “*” of the communication channel 636).

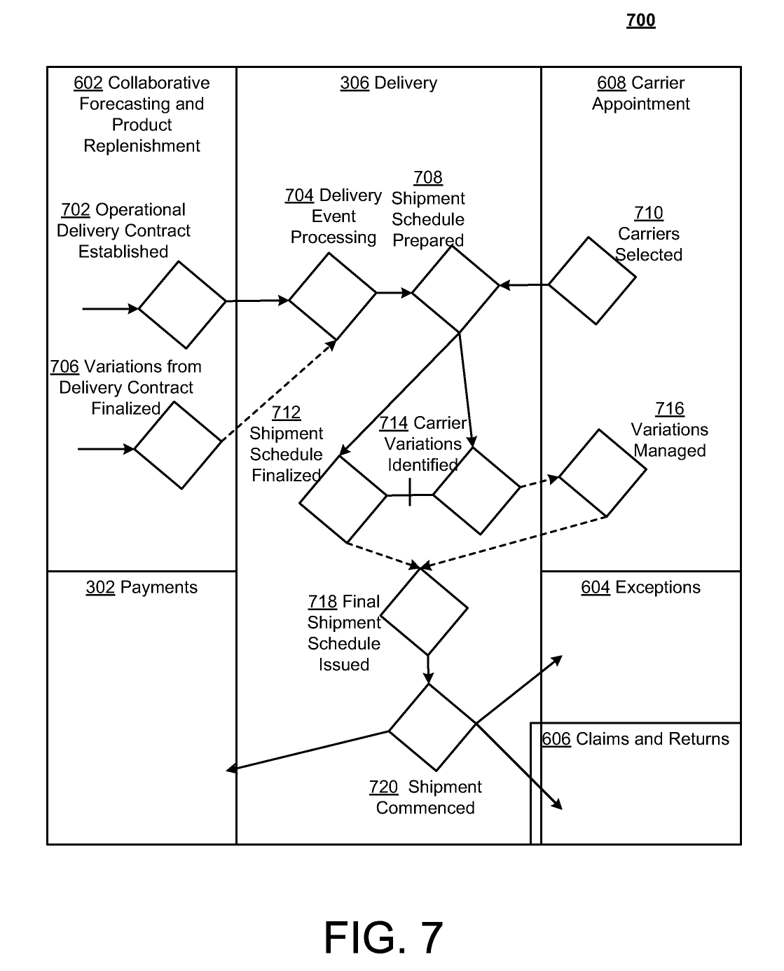

FIG. 7 is a block diagram 700 of the example choreography model of FIG. 6, illustrating additional example views. More specifically, FIG. 7 includes a milestone view 700 in relation to the domain view 600a of FIG. 6 (and most particularly, in relation to the delivery domain 306).

In the example of FIG. 7, a milestone 702 for operational delivery contract established (e.g., a delivery contract for the next three months is finalized) leads to a milestone 704 for delivery event processing (e.g., a next-subsequent delivery), whether or not a milestone 706 for variations from the delivery contract are finalized (as shown by the weak precedes relationship between milestones 706 and 704). A milestone 708 for a shipment schedule being prepared may come after the milestone 704, and after a milestone 710 for selection of one or more carriers. Then, as indicated by the inhibit relationship between milestones 712 and 714, either a shipment schedule may be finalized at the milestone 712, or carrier variations may be identified at the milestone 714. In the latter case, a milestone 716 for management (e.g., resolution) of the carrier variations may lead to a milestone 718 for issuing of a final shipment schedule. Or, as shown, the issuing of the final shipment schedule also may follow directly form the finalization of the shipment schedule milestone 712. A milestone 720 represents commencement of the shipment.

In FIG. 7, the milestone view is shown in conjunction with corresponding domains. For example, the milestones 702, 706 are associated with the domain 602 for collaborative forecasting product replenishment, while milestones 710 and 716 are associated with the domain 608 for carrier appointment. Meanwhile, the milestones 704, 708, 712, 714, 718, and 720 are associated with the delivery domain 306, and the milestone 720 for commencement of shipping, as shown, may generally lead to one or more of the payments domain 302, the exceptions domain 604, and/or the claims and returns domain 606.

FIG. 8 is a block diagram 800 of the example choreography model of FIGS. 6 and 7, illustrating additional example views. Specifically, FIG. 8 includes a scenario-based view 800 shown in the context of the milestone view 700 of FIG. 7. As shown in FIG. 8, and as referenced above, scenario constructs may include one or more actual interactions between entities or roles, compiled or collected into one or more scenarios that may be spliced between milestones of the milestone view 700. In some implementations, a composite of a set of scenario views (perhaps together with associated milestones) may be referred to as an interaction-based view. In this regard, it may be appreciated that scenario-based views may be considered decompositions of the larger interaction view, i.e., may be said to provide a separate, horizontally-decomposed view(s) of the choreography model 104. Such decomposition, while useful, is different from the vertically-separated views described with respect to FIGS. 3A-3D. That is, the views 300a-300d, while each providing a different view of the choreography model 104, do so in a manner that is essentially complete and comprehensive for the choreography model 104, even if very abstract or high-level. In contrast, scenarios composed into (or decomposed from) an interaction model are useful in describing their own particular context of the choreography model 104.

In FIG. 8, then, a scenario 802 (in which specific interactions contained therein are purposefully left blank) may lead to the milestone 704 for delivery event processing, and, similarly, a scenario 804 may lead to the milestone 710 for selection of carriers. Then, a scenario 806 related to an investigation of replenishment for a delivery event may occur, which will lead either to the milestone 712 for finalization of shipment schedule or the milestone 714 for identification of carrier variations.

As shown, the scenario 806 may include a plurality of interactions 808, 810, 812, 814, and 816, in which one role sends a message to another role. For example, in the interaction 808, as shown, the retailer 612 may send a message regarding a store/inventory report to a manufacturer 614 (e.g., over the channel 616 of FIG. 6). Then, in reply, in interaction 810, the manufacturer may send a message regarding final delivery replenishment to the retailer. The retailer may then send a message to the manufacturer acknowledging the replenishment in interaction 812, with may lead to either (but not both, as shown by the inhibit relationship therebetween) of the interactions 814 and 816. That is, either the shipper 624 may send a message indicating that carrier capacity is sufficient in interaction 814, or may send a message indicating carrier capacity is insufficient in the interaction 816. Since these are mutually exclusive, it follows that, as already discussed (and as shown again in FIG. 8), either (but not both) of milestones 712 and 714 may ensue.

Although shown as blank, it may be appreciated that the scenario 802 may contain similar interactions. A designer may click on, or otherwise select, the scenario 802, in order to modify or add interactions therein.

FIG. 9 is a flowchart 900 illustrating a first consistency check that may be performed for the systems of FIGS. 1 and 4. In the example of FIG. 9, it is assumed that consistency checking will be performed for each domain of an enterprise project. Then, for each domain, various consistencies may be checked, such as consistencies between role-based and milestone views, role-based views and interaction-based views, and milestone and interaction-based views. After these consistency checks have been performed, e.g., by the consistency checker 122 of FIG. 1, then the relevant domain may be considered to be in a synchronized state.

FIG. 9 relates to the particular example of consistency between role-based views and interaction-based views, such as the role-based view 600b for the delivery domain 306 of the domain view 600a of FIG. 6, and the interaction view 800 of FIG. 8. In FIG. 9, an interaction in the interaction-based view is selected (902). For example, the interaction 808 may be selected.

Then, the corresponding role pair R1, R2 of the interaction may be selected, as well as the message type MT (904). In the example, the roles are retailer 612 and manufacturer 614. Although not illustrated in FIG. 6 or FIG. 8, the message type MT of the message “store/inventory report” may be generically designated as “message type 1” for the purposes of this example. Then, the consistency checker 122 may search the role-based view 600b for an interaction between R1 and R2 (906), which in this example may be satisfied by an interaction associated with the channel 616 for delivery notification.

Then, as an initialization, a roles-consistent flag may be set to false (908). If an interaction relationships exists in the role-based view (910), then it may be determined whether a role multiplicity (if any) between R1, R2 corresponds in the two views (912) (e.g., R1 and R2 should not have a one-to-one relationship if the interaction relationship is one-to-many). Finally, if the message type MT is supported in the channel (here, the channel 612) (914), then the roles-consistent flag may be set to true (918). Otherwise, as shown, if any of these conditions are not met, then an inconsistency may be designated (916), e.g., the roles-consistency flag may be kept at false.

It will be appreciated from the above description, and from FIG. 6, that a given channel may be used for multiple interactions and message types. Therefore, in implementing the flowchart 900, steps may be taken not to use a channel to establish consistency when that may already have been used as a basis for establishing consistency of a previously-checked interaction. Also, it is possible that interactions may be associated with more than two roles, and the flowchart 900 may be modified accordingly in such cases.

The flowchart 900 may be used to check whether each interaction in the interaction view or model is consistent with the role-based view. Conversely, it may also be determined that every interaction relationship (e.g., channel) of the role-based view has at least one corresponding interaction in the interaction-based view (e.g., a check may be run to determine whether there may be interaction relationships (channels) in the role-based view without a role pair from the interaction view marked with a role-consistent flag (as a result of the operations of FIG. 9).

In summary, then, a scenario-based (or interaction-based) view may be consistent with a role-based view in so far as they both may be part of the same domain and the domain is in a synchronized state. Further, the roles of elementary interactions should have correspondence with roles which do communicate (i.e. they share the same channels). It should be noted that multiple interactions between the same role pair can pertain to one channel. Still further, the messages passed between interacting roles are type compatible and in the same direction as those allowed across those channels). Finally, as referenced above, multiplicity of interactions (repeated interactions) should correspond with role cardinality.

FIG. 10 is a flowchart 1000 illustrating a second consistency check that may be performed for the systems of FIGS. 1 and 4. Specifically, FIG. 10 provides a consistency check between a milestone view and an interaction view (comprising various scenarios, as in the example of FIG. 8). In general, an interaction-based model should be consistent with a milestone model in so far as they are part of the same domain and the domain is in a synchronized state, and the dependency relations of the milestones are not violated.

In FIG. 10, the various scenario views may be merged into an interaction-based view, as described above (1002). If successful, then the milestone view may be searched for dependent milestones M1 and M2, where, as already described, the dependency may be of a type referred to as precedence, weak precedence, or inhibits (1006).

If the dependency is a precedence dependency (e.g., M1 must execute before M2 may execute), then the consistency checker 122 may check the interaction model to see whether a precedence path exists between M1 and M2 (1008). In other words, if M2 follows M1, then it may be sufficient for the sake of consistency to say that, within the interaction model, M1 and M2 have a direct or indirect precedence path (that is, between M1 and M2, either no interactions exist, or interaction which do exist are also in a precedence relationship). If so, then a consistency flag may be set to true (1012).

If there is no such precedence path between M1 and M2, e.g., if there is only a weak precedence path, then the consistency checker 122 may analyze the interactions to determine whether all interactions prior to M1 will be executed (1010). If so, then consistency may still exist, and the consistency flag may be set accordingly (1012). For example, if M1 is a predecessor to an interaction in a precedence or weak precedence relationship and there are no guarded (conditional) interactions or inhibited interactions targeting any preceding interactions of M1, then it may be deduced that there will be an interaction between M1 and M2, as predicted in the interaction-based model, so that consistency may be preserved. Otherwise, the milestones consistency flag may be set to false (1014).

If M1 and M2 are in a weak precedence relationship (1006), then the interaction model may be scanned to determine whether a precedence or weak precedence path exists therein between M1 and M2. If so, this is sufficient to establish consistency, and the flag may be set accordingly (1012); otherwise, the flag may be set to false.

Finally, for an inhibition relationship (1006), the interaction model may checked for an inhibited interaction between M1 and M2. That is, in the interaction model, two interactions should be present such that the first interaction follows M1 and the second interaction precedes M2, and the two interactions have an inhibition relationship between them, so that inhibition is consistently maintained in the interaction model as in the milestone view (1018). It should be noted in this regard that the first interaction should directly or indirectly precede M1 in a precedence relationship, or in a precedence or weak precedence relationship such that there will be no prior inhibitions of that interaction (e.g., via guarded interactions or interactions which cause inhibition). If so, then the flag mat be set to true (1012). Otherwise, as referenced above with respect to operation (1010), interactions between M1 and M2 may be checked to determine whether all interactions therebetween will be executed (1020). To maintain an inhibition relationship if not all of the interactions will be executed, then inhibition may be maintained and the flag set to true (1012). Otherwise, if all interactions will be executed between M1 and M2, then inhibition consistency is not maintained and the flag thereby set to false (1014).

Thus, the above description provides techniques by which choreography models may be developed using multi-staged and multi-viewpoint techniques. In so doing, and as referenced above, one viewpoint might inter-play with another viewpoint in the development of a choreography model. In the early stages of analysis in particular where the models being captured are fluid and subject to change, inter-play of the viewpoints may be highly advantageous.

For example, as referenced above, one-directional consistency checking may be useful. That is, consistency checking implies that the different models used need mutual consistency, so that concepts in one have correspondence with related concepts in the other, and vice-versa. However, when developing models, support for one directional consistency may be advantageous, because in an early or intermediate state of development may modelers already know that some of the models are still in flux, but nevertheless need checking against already well developed models. As an example, a milestone or role-based model may be used to check correctness of modeled interactions in a scenario, or in the whole interaction-based model. Uni-directional consistency allows consistency of modeled interactions to be checked, without requiring all interactions to correspond to the more coarse-grained models. The consistency checker 122 may then qualify the extent of consistency that has been established in the case that partial or one-directional consistency checking has been used

In the examples herein, and in other examples, the distinct views described here may nonetheless be seamlessly presented. For example, role-based views and milestone views may be presented in some implementations are being monolithic with respect to an associated domain. However, even with their coarse-grained detailed, these models will be quite large for real-scale domains. Therefore, it may be advantageous to view parts of these views in tandem with interaction-based models.

Thus, as an interaction-based model is viewed for one or more individual scenarios, then the corresponding part of the role-based or milestone based model could be viewed as well. Moreover, some views could mix different aspects together. For example, a set of scenarios could be viewed as both role-based and interaction-based viewpoints respectively, with the detailed interaction-based details expanded when a specific scenario is being analyzed. This allows coarse-grained surrounding details to be understood, while more detailed interactions are being viewed and captured. It should be noted that in this example, the milestone model is used to determine related scenarios, which in turn derives which parts of the role-based view should be displayed. Further, when viewing a role-based view, a designer may select a channel to determine which message types are associated therewith, and may also be given the option to view the scenario-based view from the role-based view. Moreover, in viewing the corresponding scenario view, e.g., in the display 132, the designer may be permitted to actually model the scenario view at that point (e.g., by constructing a particular interaction by selecting from the list of available messaging interactions detailed in the role-based view).

In further implementations, neighborhood viewing may be provided based on the target of viewing (e.g. milestones or scenarios). For example, and similar to the example just given, a role-based model may be viewed based on a scenario. By relationship to the underlying milestone dependencies, the related scenarios could be determined, and, accordingly, the role-based model view could be expanded. For example, in FIG. 8, the scenario 802, which is shown as blank, may be clickable or otherwise selectable, so that the designer may “zoom in” to the scenario 802 to model or examine the interactions contained therein.

In still further implementations, it may be observed that large numbers of scenarios may arise out of small or large variations of basic scenarios. For example, purchase orders may have a standard form, but may vary slightly when involving goods which are large, small, flammable, biodegradable, or otherwise associated with some small variation that may affect shipping. Consequently, the implementations described herein may be used to capture generic interaction structures, to allow later addition of more specialized parts. Sub-types of scenario models may be created by allowing generic interaction-based models to be inherited (e.g. purchase order processing), and adding further interactions. Then, by defining appropriate and well-defined boundaries, consistency checks may be applied to a generic scenario, but will be carried into the specialized scenario (e.g. small purchase order processing). In some example implementations, the following rule be preserved from the generic structure: “direct or indirect precedence or weak precedence path between milestone dependencies such that there are no interactions which will not be executed.” If any new interaction is added to the generic structure which violates this rule, it may be removed.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program described above, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods may be performed by one or more programmable processors executing a computer program to perform functions by operating on input data and generating output. Methods also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Thus, while certain features of the described implementations have been illustrated as described herein, many modifications, substitutions, changes and equivalents will now occur to those skilled in the art. It is, therefore, to be understood that the appended claims are intended to cover all such modifications and changes.

What is claimed is:

1. A system comprising:
a choreography manager configured to manage a choreography model governing interactions between at least two entities, the choreography manager including
a first choreography modeler configured to provide a first view of the choreography model, the first view including first constructs that are associated with a first sequence degree characterizing a degree to which a sequence of the interactions between the entities is provided;
a second choreography modeler configured to provide a second view of the choreography model, the second view including second constructs that are associated with a second sequence degree characterizing the degree to which the sequence of the interactions between the entities is provided; and
a choreography mapper configured to relate the first view to the second view, and configured to relate the first constructs to the second constructs.

2. The system of claim 1 wherein the sequence of interactions includes an order of message exchanges between pairs of the at least two entities, and wherein the first sequence degree does not require any specified order for the message exchanges.

3. The system of claim 1 wherein the first choreography modeler includes the first constructs as entity-based constructs associated with characterizations of the at least two entities.

4. The system of claim 1 wherein the first choreography modeler includes a domain modeler configured to provide the first constructs including domain constructs characterizing functional scopes of the at least two entities.

5. The system of claim 4 wherein the domain modeler provides the domain constructs in contact with one another in order to define a possible message interaction therebetween, without specifying a occurrence or order of the possible message interaction.

6. The system of claim 1 wherein the first choreography model includes a role-based modeler configured to provide the first constructs including role constructs characterizing roles taken by one or more of the at least two entities.

7. The system of claim 6 wherein the role-based modeler is configured to provide pairs of the role constructs as being connected by communications channels when the pairs of the role constructs are permitted to share one or more message types associated with one or more instances of the choreography model.

8. The system of claim 1 wherein the second choreography model includes the second constructs as action-based constructs representing ordered actions taken by at least one of the entities during execution of the choreography model.

9. The system of claim 1 wherein the second choreography model includes a milestone modeler configured to provide the second constructs as milestone constructs representing discrete points of progress in the choreography model and having a sequential dependence on one another.

10. The system of claim 1 wherein the second choreography model includes a scenario modeler configured to provide the second constructs as scenario constructs representing one or more ordered interactions between the at least two entities.

11. The system of claim 1 wherein the choreography mapper comprises a consistency checker configured to determine a consistency of multiple views of the choreography model, including one or more of the first view and the second view, in representing the choreography model.

12. The system of claim 1 wherein the choreography mapper comprises a choreography model aggregator configured to receive the first view and the second view and to output the choreography model for implementation thereof.

13. The system of claim 1 comprising a display generator configured to provide the first view and the second view including access from one or both of the first view and the second view to another view of the choreography model, based on a selection of one or more of the first constructs and the second constructs, respectively.

14. A system comprising:
a choreography manager configured to manage a choreography model governing interactions between at least two entities, the choreography manager including
a first choreography modeler configured to provide a first view of the choreography model, the first view including entity-based constructs representing at least one of the entities;
a second choreography modeler configured to provide a second view of the choreography model, the second view including action-based constructs representing actions taken by at least one of the entities during execution of the choreography model; and
a choreography mapper configured to relate the first view to the second view, and configured to relate the entity-based constructs to the action-based constructs

15. The system of claim 14 wherein the first choreography modeler includes at least one of a domain modeler configured to provide a domain view, and a role-based modeler configured to provide a role-based view, and wherein the second choreography modeler includes at least one of a milestone modeler configured to provide a milestone view, and a scenario modeler configured to provide a scenario-based view.

16. The system of claim 15 wherein the choreography mapper is configured to provide access between a domain view of the domain modeler to one or more of:
a role-based view of the role-based modeler,
a milestone view of the milestone modeler, and
a scenario view of the scenario modeler.

17. The system of claim 16 wherein the choreography mapper is configured to provide scenarios of the scenario view placed sequentially between milestones of the milestone view.

18. The system of claim 14 comprising a display generator configured to provide the first view and the second view as being accessible through one another within a user interface for display thereon, the user interface comprising:
a consistency selector configured to receive a request for a consistency of the first view and the second view in representing the choreography model; and
an aggregation activator configured to aggregate the first view and the second view into the choreography model, for implementation thereof by the at least two entities.

19. A method comprising:
determining one or more of a domain view and a role-based view of a choreography model governing interactions between at least two entities;
determining one or more of a milestone view and a scenario view;
relating one or more of the domain view and the role-based view to one or more of the milestone view and the scenario view; and
providing the choreography model, based on the relating.

20. The method of claim 19, comprising:
providing at least two of the domain view, role-based view, milestone view, and scenario view on a display;
providing a link between the provided views, the link providing access to a selected view of the provided views from a current view of the provided views; and
providing the selected view for modeling thereof in conjunction with the current view.
